(19) United States
(12) Patent Application Publication
(10) Pub. No.: US 2015/0082378 A1
(43) Pub. Date: Mar. 19, 2015

(54) SYSTEM AND METHOD FOR ENABLING SCALABLE ISOLATION CONTEXTS IN A PLATFORM

(71) Applicant: Apcera, Inc., San Francisco, CA (US)

(72) Inventor: Derek Collison, San Francisco, CA (US)

(21) Appl. No.: 14/490,387

(22) Filed: Sep. 18, 2014

Related U.S. Application Data
(60) Provisional application No. 61/879,638, filed on Sep. 18, 2013.

(51) Int. Cl. H04L 29/06; H04L 29/08

(52) U.S. Cl. CPC H04L 63/20; H04L 67/10
USPC 726/1

(57) ABSTRACT

A system and method for operating a computing platform that includes distributing a job within an isolation context to a computing platform, which includes receiving a deployment request that includes a set of isolation context rules; transferring a job instance update as specified by the deployment request to a machine of the computing platform; and at the machine, instantiating the job instance within an isolation context and configuring the set of isolation context rules as a set of resource quotas and networking rules of the isolation context; and enforcing the set of resource quotas and networking rules during operation of the job instance within the computing platform.

### CROSS-REFERENCE TO RELATED APPLICATIONS

This application claims the benefit of U.S. Provisional Application Ser. No. 61/879,638, filed on 18 Sep. 2013, which is incorporated in its entirety by this reference.

### TECHNICAL FIELD

This invention relates generally to the platform as a service field, and more specifically to a new and useful system and method for enabling scalable isolation contexts in a platform in the platform as a service field.

### BACKGROUND

Innovation in computing platform applications can involve new features, new services, new applications, more data, more information and more insight. However, there are numerous factors like development, deployment, and policy limiting such innovation on platforms. Development is complex because of the languages, framework, and collection of services. Deployment can hamper innovation due to the high volume and time required to managed deployment of a system. Managing a policy around what components can talk with is challenging and difficult to enforce. Building a computing application in present infrastructure can involve tradeoffs of moving faster and increasing risk or decreasing risk and slowing down.

As shown in FIG. 1, prior art has included deploying apps within segmented network boundaries. The network boundaries can have associated load balancing and firewalls. Deployed apps, network stacks, or jobs can exist within one of those network boundaries, but in some cases app or job dependencies can require an app (e.g., app C composed of C1 and C2) to be split between different network boundaries. Deploying apps can require considerable time and effort. At scale, architecting an app within different network boundaries can take several weeks. And additionally, changes to apps may cause a waterfall of updates to dependent apps. Thus, there is a need in the platform as a service field to create a new and useful system and method for enabling scalable isolation contexts in a platform. This invention provides such a new and useful system and method.

### BRIEF DESCRIPTION OF THE FIGURES

FIG. 1 representation of prior art use of network boundaries;

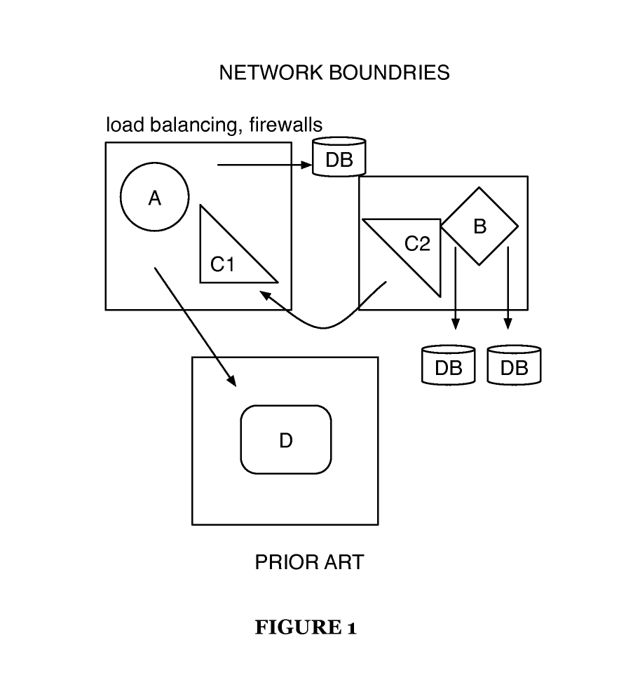

FIG. 2 a schematic representation of a system for providing isolation context of a preferred embodiment;

FIG. 3 is a schematic representation of features of an isolation context of a job;

FIG. 4 is a schematic representation of architecture of a corporate network, a platform network, and a virtual network;

FIG. 5 is a schematic representation of management of a platform network.

FIG. 6 is a schematic representation granting access to a service of the platform network residing on a different host;

FIG. 7 is a schematic representation of granting access between isolation contexts;

FIG. 8 is a schematic representation of a method of a preferred embodiment;

FIG. 9 is a detailed flowchart block diagram of a variation of distributing a job instance of a preferred embodiment;

FIG. 10 is a detailed flowchart block diagram of a variation of transferring a job instance of a preferred embodiment;

FIG. 11 is an exemplary schematic representation of binding two job instances; and

FIG. 12 is a schematic representation of modifying an isolation context in response to changes of a second isolation context.

### DESCRIPTION OF THE PREFERRED EMBODIMENTS

The following description of preferred embodiments of the invention is not intended to limit the invention to these preferred embodiments, but rather to enable any person skilled in the art to make and use this invention.

### 1. System for Enabling Scalable Isolation Contexts in a Platform

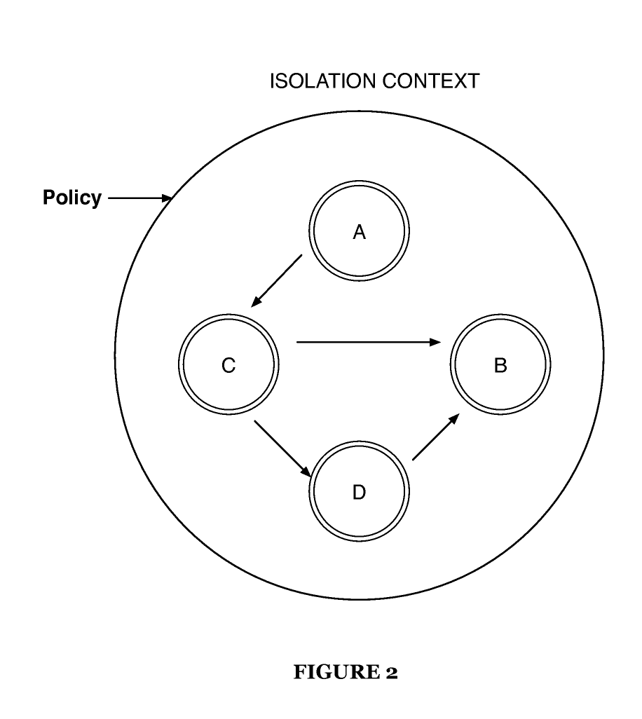

As shown in FIG. 2, system for enabling scalable isolation contexts in a platform can include a plurality of isolation contexts 110 within a networked computing platform system network. The system can include three networks: a first network (i.e., a corporate network) 120, a second network (i.e., a platform network) 130, and a third network (i.e., virtualized network or isolation context network) 140. The system functions to create a computational resource management environment that enables isolation contexts to operate and execute various application and service solutions within a computing platform. The system leverages the properties of isolation, insulation, and automation that the isolation context provides to jobs. The system is preferably used by outside entities to implement computing solutions. For example, the system can be used as a platform as a service (PaaS) platform to which outside developers and account holders can deploy various application and service solutions. The system can be multitenant distributed computing solution, but the system may alternatively be operational within a system instance within an on-premise network. The system is preferably highly scalable, secure, and provides control and visibility into the communication and architecture of jobs deployed on the platform network 130.

The system can preferably include any suitable number of isolation contexts active within the computing platform. Each instance of a job (e.g., app, service, module, etc.) is preferably deployed within an isolation context. A developer preferably uses a set of developer tools to define, deploy, and manage a set of jobs that are distributed to the computing platform. A given job may have any suitable number of instances running on different machines within the computing platform. Additionally, any suitable set or combination of job instances may have operational dependency on other jobs. Similarly, the operation of the job may require operational dependence on resources existing on the corporate network (e.g., on-premise enterprise intranet or the public internet). The system preferably additionally includes a set of internal platform services such as a messaging system 150, an API service 160, a job managers 170, instance manager services 180, and/or additional components that function to coordinate setup and operation of a set of jobs. The internal platform services can determine when a job should be deployed (e.g., a job instance failure or API request for a new instance), determine how to wrap the job in an isolation context 110 and distribute the wrapped job.

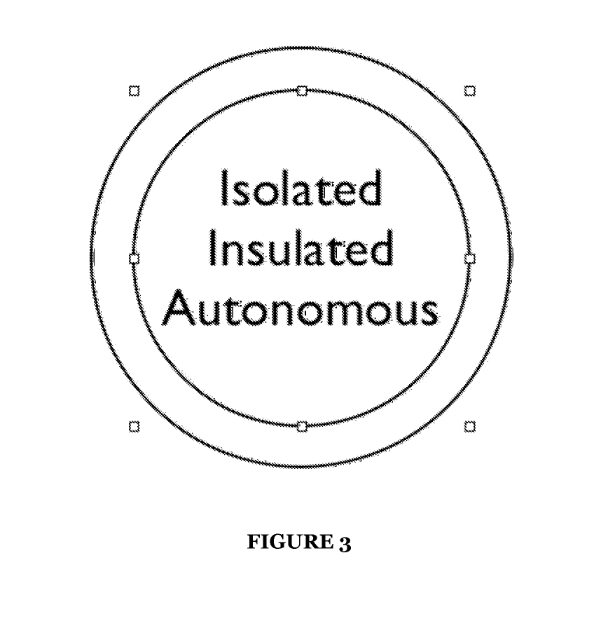

As shown in FIG. 3, the isolation contexts 110 preferably exist within the platform network 130. Isolation contexts 110 function to isolate, insulate, and automate a job within a network platform. An isolation context 110 preferably includes an isolation context layer around interfaces of a job. An isolation context 110 is preferably a container in which a job instance is instantiated and run. A container is preferably an operating system kernel feature that enables isolated user space for a job. A single machine can preferably run multiple isolation contexts 110. Individual containers on a machine may share a host operating system and, in some instances, bins/libraries. An isolation context 110 may alternatively be any suitable type of operating system-level virtualization such as virtualization engines, virtual prov. It may be appreciated that other embodiments may use alternative virtualization mechanisms such as full machine virtualization (e.g., virtual machines). A job can be a service, an app, database, a server, a router, a module, a resource, or any suitable operable entity deployed on the platform network 130. A machine can be server, host, or any suitable computing resource.

In one preferred implementation, the container of the isolation context no can utilize a Linux control group (cgroup) and IPtables. The control group can be used to define control the access that a container has to system resources relative to other containers. The IPtables may be used to define the networking communication rules for ingress and egress traffic. As an alternative to IPtables, generic route encapsulation (GRE), point-to-point tunneling protocol (PPTP), vSwitches, or other suitable mechanisms may be used. An isolation context 110 can preferably be constructed for a set of different operating platforms and/or environments. Different tools and mechanisms may be used to construct an isolation context. In one variation, the computing platform includes a diverse set of operating systems such as Windows and Linux. Operating system specific isolation context versions are preferably used for the different operating system types, and appropriate jobs can be deployed to at least one type of machine. The isolation context 110 may alternatively be implemented for any suitable platform.

The isolation property of the isolation context 110 preferably provides security and fault tolerance to the job. An outside entity (e.g., a developer account of the computing platform) can deploy multiple job instances, which results in multiple isolation contexts no. The isolation contexts 110 of the job instances can be configured such that a system can be operated on top of the infrastructure of the platform network 130. From the perspective the outside entity they are deploying a job instance and defining a set of resource and networking policy related to that job; That job deployment request is fulfilled by deploying the job instance within an isolation context 110.

A job is insulated in the sense that it is limited to communicating with particular resources. An isolation context 110 preferably includes a set of resource quotas and networking communication rules that define and limit how a job can operate. An isolation context is preferably deployed with a set of policy rules or configuration that defines usage quotas and network communication (e.g., ingress and egress) limits. Rules can exist and be enforced in the switches, different networking elements, and other components determining operation of the isolation context 110. By default the isolation context may be limited to a bare minimum. For example, by default no network channels may be open to the job. The networking communication rules preferably open different channels for ingress and egress traffic. For example, a job may need access to a database job to which communication to and from a particular IP address on a particular port may be opened; and if the job needs to communicate to the public internet communication is opened up to access the Internet.

Automation preferably refers to the property of an isolation context 110 to be placed or instantiated anywhere in a network platform, and the system enables the isolation context 110 to determine who and what the job can communicate with and what job or services can talk to it. The automation property of an isolation context 110 makes the job network agnostic. A job instance in an isolation context 110 can preferably be deployed or moved to any machine capable of running the job and the job will operate the same. The computing platform preferably provides all the automation of updating the job and service dependencies. The system can preferably avoid waterfall-style updates of dependent jobs when one job changes. An isolation context 110 is additionally metadriven. As mentioned an isolation context 110 can include a plurality of rules or policies that define who and what resources the job of the isolation context 110 can communicate with, which further facilitates automation of a job within a network platform. These resource and networking policy rules may be automatically applied through the set up of an isolation context, which functions to enforce that all deployed jobs be compliant to resource and network.

An isolation context 110 preferably includes a inner virtual network interface that can be statically defined with network mapping. The inner virtual network interface communicates to an outer virtual network interface of the host operating system through the virtual network 140. As an aspect of insulation, changes outside of the isolation context 110 to dependent jobs (e.g., other services, apps, or resources the job communicates with) are manifested in updates to the outer virtual network interface, which allows the inner virtual network interface bindings and routes to be static.

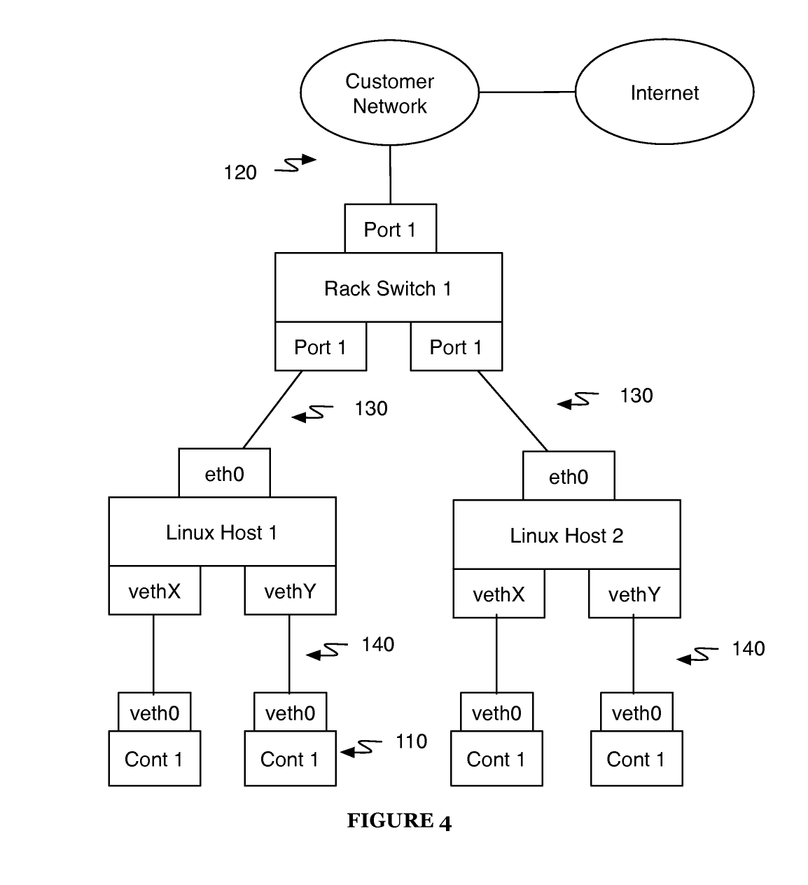

The networking environment of the system includes three networks as shown in FIG. 4. The three network types can be implemented within a double NAT environment that includes SNAT and DNAT.

The first network or the corporate network 120 is the host network in which the system operates. The first network can be a cloud hosted distributed computing platform such as Amazon's web service cloud or any suitable computing cluster or platform. The first network can alternatively be an enterprise private network. In one implementation, the first network is an on-premise network of a business. A customer is preferably connected on the first network. The customer can be characterized as an entity deploying or managing resources to the system. The system is preferably implemented as a blended version of an infrastructure as a service, platform as a service, and software as a service. The corporate network 120 can have a small range of static IPs used for network equipment and to front connectivity for a reverse proxy server (e.g., Nginx) and any suitable exposed service

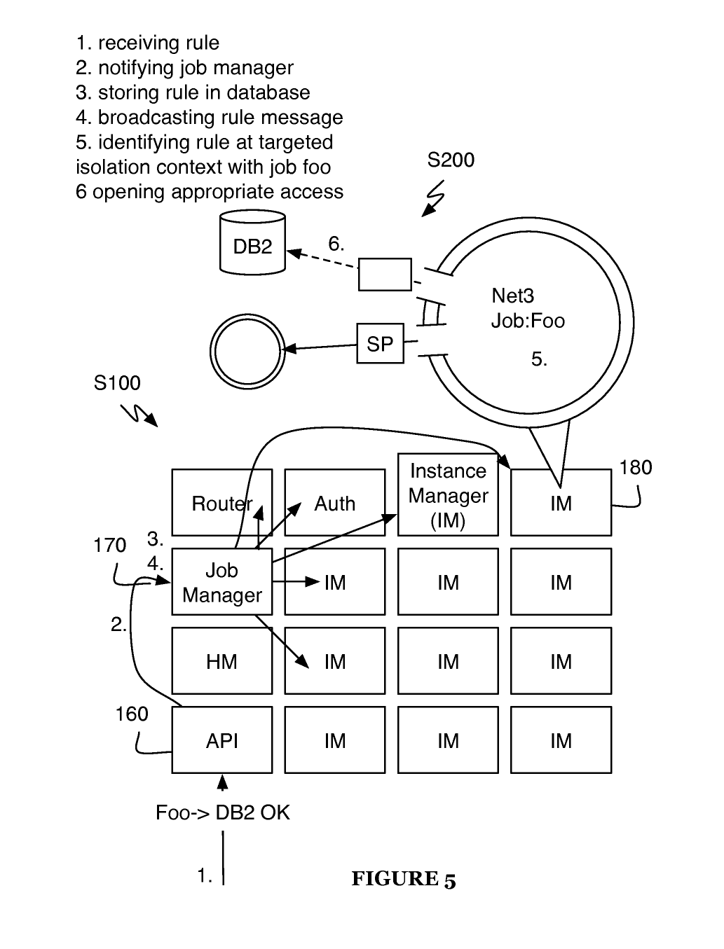

The second network or the platform network 130 functions to provide connectivity between different machines. The platform network 130 can act as a routing grid that can be used between jobs or more specifically isolation contexts 110. The platform network 130 can be the physical network presented by the rack switch to the physical hardware deployed within a customers computing rack. Rules of an isolation context 110 can define that the platform network 130 is transparent or otherwise not directly accessible from within an isolation context 110. Preferably, the IP addresses of the platform network 130 do not conflict with pre-existing IP ranges of a customer such that different jobs in the second network can contact services exposed on the corporate network 120. Different services or jobs may run on the platform network 130 such as the internal platform services. Exemplary services can include a messaging system 150, an API service 160, a job managers 170, instance manager services 180, an authentication server, a health manager, NATS, a reverse proxy (e.g., Nginx), a package manager, a log aggregation, a metric aggregation, database services (e.g., MySQL, PostgreSQL, Redis, and the like), and any suitable type of service. Additionally, machine specific services can be exposed by every running host such as network time protocol (NTP) servers, data communication protocols (e.g., SSH), message logging (e.g., Syslog) and/or any suitable service for exposure. Any number of instances of a service can be operated. As shown in FIG. 5, multiple instance managers will preferably operate to manage instances of different isolation context 110 jobs.

The third network or virtual network 140 functions to provide a network scenario for isolation contexts no. The virtual network 140 can exist on a virtual switch on the machine running an instance manger of an isolation context 110. The virtual network 140 can be a point-to-point virtualized network switch that exists between a host operating system (the booted operating system running the instance manager) and the isolation context 110. The host operating system endpoint is preferably the outer virtual network interface, and the isolation context 110 endpoint in the virtual network 140 is preferably the inner virtual network interface. The host operating system can additionally include access to the platform network 130. IP addresses of the virtual network 140 similarly do not conflict with pre-existing IP ranges of a customer network. However, the virtual network 140 may not be routable since all IPs will be point to point. Customer instances preferably have visibility into the virtual network 140. The isolation context 110, which can be described as a customer container, is on one end of the network, and the host OS controlled by the system is on another end of the network. The host OS side of the virtual network 140 can block all traffic not specifically approved. Some variations may include rules to block only a subset of all traffic not specifically approved. Blocking traffic can include blocking unknown protocols, malformed packets, and the like. Traffic Mocking can provide a first layer of security for the isolation context 110. A customer or other entities are preferably prevented from using raw mode networking to circumvent restrictions and isolation. A customer can have access to networking within the isolation context 110. The access can be granted to specific destinations, which opens up an access control list (ACL). Granted access can potentially rewrite packets and enable NAT. There may be several different ways of granting access. Granting different access scenarios can generally include allowing packets that meet particular criteria to be NATed to the platform network 130. The platform network 130 can then SNAT the packets to the corporate network 120. The criteria can identify packets with source IP addresses assigned to an isolation container to prevent spoofing. The criteria can additionally identify packets with source IP addresses of the veth device on the host side of the isolation context 110 to prevent hopping containers/isolation contexts no. As an example, an isolation context 110 can have access granted to the internet or some alternative public network with the above spoofing and hopping criteria in addition to a set of protected IPs. As another example, an isolation context 110 can have access granted to a specific set of a corporate network 120. IPtable rules on a host could be updated to prevent spoofing and hopping containers as well as requiring the packet have a destination in a range given in the NATbinding. Access to a corporate network 120 can enable isolation containers to communicate to resources outside of the platform network 130. For example, a customer may have a system external to the one implemented in the system and use the customer network to bridge to integrate the two systems. A more specific case is that access is granted to a particular service on the corporate network 120. A URI such as “mysql://database.example.com” can be resolved. A hostname is extracted; a port is inferred from /etc/services; and NAT is enabled for packets matching criteria of spoof prevention, container hopping prevention, the packet destination matching the IP resolved from the hostname in the URI, and the packet having a destination port that matches the port resolved from the URO or /etc/services.

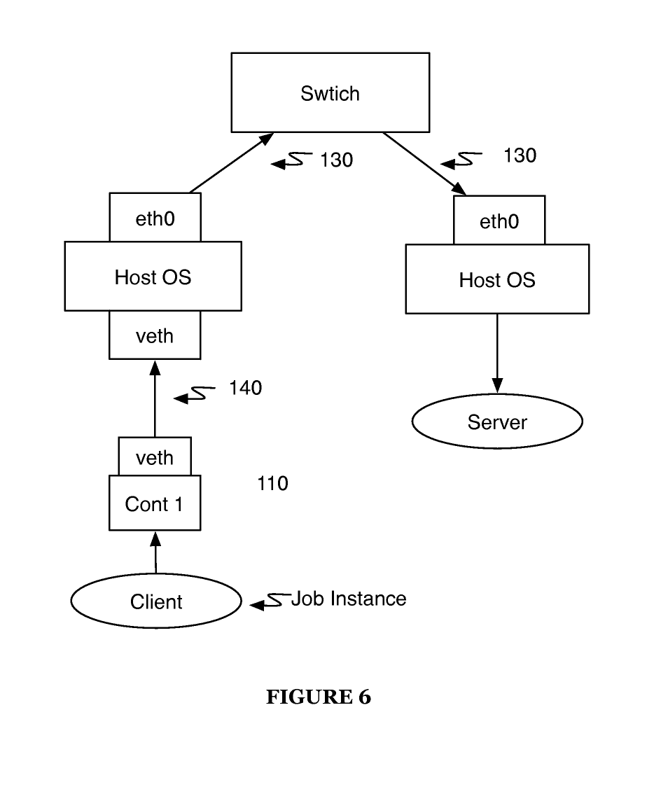

Access can additionally be granted to jobs or service within the platform network 130. There may be various implementations of granting such access. In a first instance, shown in FIG. 6, the service of interest resides on a machine other than the one that is initiating the request. In other words, the two isolation contexts no are physically on different hosts. In this mode, a client application sends a packet to a networking routing layer of an isolation context 110; the network routing layer in turn forwards the packet to a respective gateway, which applies the same logic as when the service on the corporate network 120 directs communication into the platform. The packet is preferably rewritten when crossing the eth of the host in both directions.

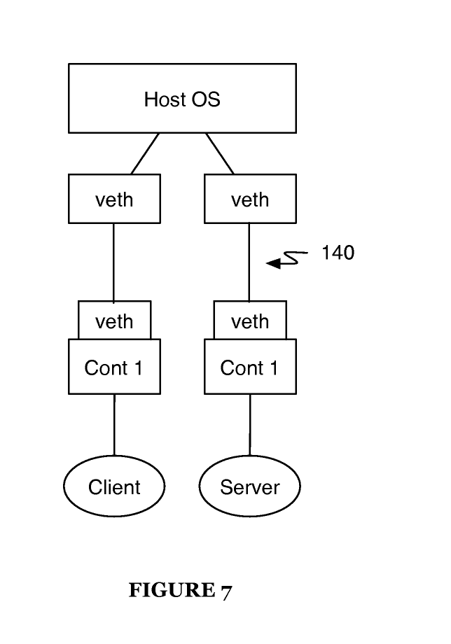

Another variation can address concerns of avoiding hairpins when the client isolation container and the service on the platform network 130 exist on the same host. To avoid failed delivery of packets and to avoid unnecessary routing out to additional resources, the system detects if an intended destination of a binding is local to a machine. If the IP listed as a destination is configured on the local machine, the system changes the logic to act as an ACCEPT rather than a NAT, which functions to short circuit the jump to etho and allowing the packet to travel from the host's virtual network interface (outer veth) to the server directly as shown in FIG. 7

As shown in FIG. 7, access can additionally be granted between two isolation containers. As the isolation containers exist in the virtual network 140 within the platform network 130, opening access is substantially similar to granting access to a service in the platform network 130. One implementation difference is the destination IP of a binding URI is the external etho address. A real backend IP address can be determined by looking up the destination of the forward in a map.

Access can additionally or alternatively be granted for other scenarios, and the above exemplary implementations can be modified in any suitable manner.

The system additionally includes an API service 160, a set of job managers 170, and instance managers 180, which function to facilitate the formulation and management of the isolation contexts 110 within the computing platform as shown in FIG. 5.

The API service 160 primarily functions to provide at least one interface through which directives may be submitted to the computing cluster. Jobs and their respective isolation contexts (along with the rules and configuration) can be submitted through the interface. The API preferably receives deployment requests which may be requests to launch a new job, add instances of another job, modify a job instance (e.g., move the job to another machine or change resource or networking rules), teardown/end a job, or any suitable type of deployment request. The API service 160 can be a REST API or any suitable type of API. A graphical user interface control portal may additionally be provided as an additional or alternative interface into the computing platform. In one variation, requests are authenticated through account credentials. Alternatively any suitable programmatic interface can be provided for interacting with the system.

The set of job managers 170 function to coordinate the distribution and higher level management of isolation contexts. A job manager can preferably processes a received deployment request (received through the API service 160) and then distributes the deployment request. The job manager 170 utilizes the messaging system 150 to communicate with a set of machines in the computing platform, identify a set of machines that are capable/willing to host the job, and then transfer the necessary information to the machine.

A job manager can store and manage a canonical version of a job and/or rules for a given job. When a machine or a particular job instance goes down, the job manager can use the canonical version to recover by redeploying the job and announcing changes to dependent job instances. A broadcasted request may inform machines of the capability and resource use of the job. In one variation, this broadcast is distributed using various tags or filters to share the deployment request to a focused subset of machines. The job manager can alternatively globally broadcast messages within the platform network. The broadcasted messages include encrypted and digitally signed content, which can only be decrypted by targeted recipients. An auth service can facilitate distribution of keys, tokens, certificate, or other suitable cryptographic mechanisms to respective components of the platform network. Preferably, a deployment request object would include the job resources (that define the job, app, or service), rule policy (that may define usage quotas, an networking routes, bindings and links), and an encrypted portion used to verify authenticity of the request. The message preferably includes instruction and configuration information to direct an isolation context to establish granted access.

Additionally, a job manager can request help from resources of the platform network during distribution of a job. The job manager can query various machines to determine a set of available and capable host machines. Various heuristics or models of determining machine availability may be used. In on preferred variation, machines determine how they respond to influence if and how they are considered for use. When receiving a deployment help request, a machine can determine if it is capable or willing to help (i.e., host the job). For example, the job manager may make a request about establishing a new job for a Windows service. The binary portion of the heuristic includes instance managers replying with a binary yes or no if they can fulfill a request. If the answer is yes, the instance manager can apply the taint heuristic. If the answer is no, the instance manager may simply not respond, but can alternatively respond indicating failure to help. For example, if the instance manager is a Linux system, the binary heuristic will be a no. The taint heuristic artificially delays responses according various factors. The factors can include memory pressure, CPU pressure, job list, and other factors. The job list is preferably used to avoid clustering of jobs on the same host. These factors determine a delay, and then response is made indicating suitability to help. The job manager then preferably accepts the desired number of instance managers. In some cases, only a single response is required. The request can additionally be canceled after the request is fulfilled. The messaging system preferably includes a mechanisms to enable the request to be ended.

The instance managers 180 function to provide a distributed self management of the isolation instances 110 and their respective jobs. An instance manager 180 is preferably monitors and announces changes relating to a job instance. A job manager 180 preferably handles monitors at least one job of a machine. The instance manager 180 may alternatively be shared across multiple job instances on the same or different machines. An instance manager can make broadcasts for changes of a job instance. These announcements are not necessarily dependent on binding but can be made to any interested object. For example, a change in the location of a job instance may make an announcement approximating the message of “to any interested party, this job instance is now running here”. Announcements can similarly be broadcasted over the messaging system 150 for the removal of a job or other suitable change to a job. The job instance 180 can similarly receive and process announcements from other instance managers 180. For example, an instance manager 180 can monitor dependent job and update bindings of the outer networking interface for the job instance if the dependent job announced that it changed.

The messaging system 150 functions to allow broadcasting of configuration and management to multiple isolation contexts no. As described above, the messaging system is preferably used in broadcasting and responding to requests between a job manager 170 and instance managers/machines 180. The messaging system 150 preferably broadcasts messages to all isolation contexts no, but may alternatively allow targeted or filtered broadcasting. In another variation, topic specific subscriptions and publications may be established between the different services of the computing platform.

The system can additionally operate in combination with semantic pipelines implemented within the platform network 130. As shown in FIG. 5, semantic pipelines (SP) such as those described in U.S. patent application Ser. No. 14/203,336, filed 10 Mar. 2014, which is incorporated in its entirety by this references can be integrated as another system element that provides another mechanism for setting and enforcing policy over a deployment.

### 2. Method for Enabling Scalable Isolation Contexts in a Platform

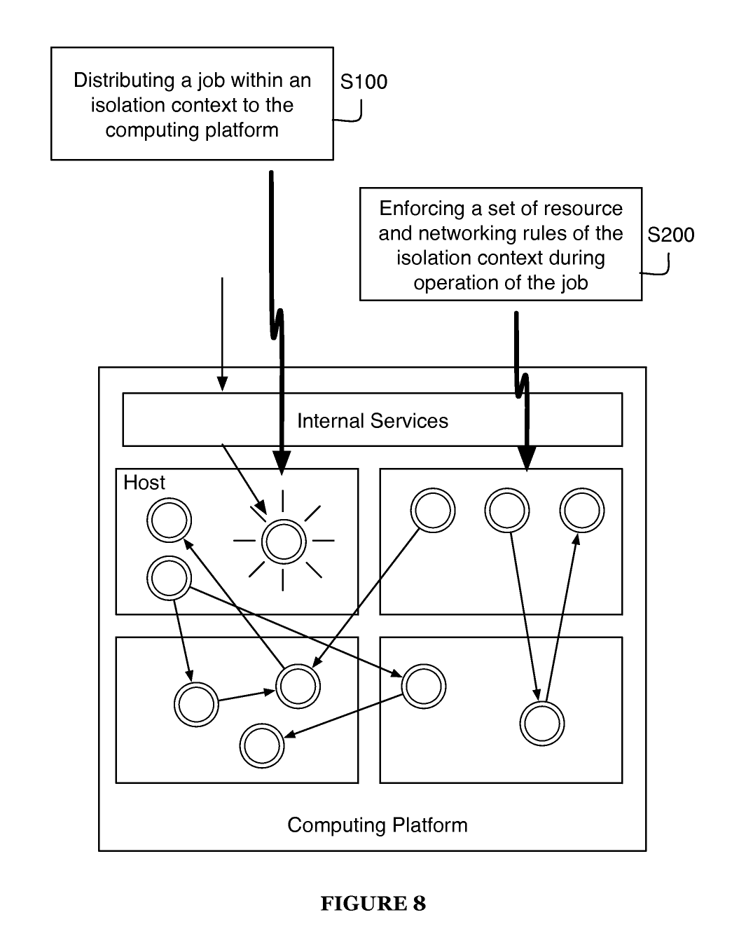

As shown in FIG. 8 and FIG. 5, a method for enabling scalable isolation contexts in a platform includes distributing a job within an isolation context to the computing platform S100 and enforcing a set of resource and networking rules of the isolation context during operation of the job S200. The method functions to provide isolation, insulation, and automation of job management within the computing platform. The method is preferably used in controlling the routing of traffic and resources usage within a platform network. The method is preferably implemented by a system substantially similar to the one above, but any suitable system may alternatively be used. By establishing jobs within isolation contexts and intelligently deploying the isolation contexts, individual jobs can achieve isolation, insulation, and automation. The method can facilitate management of rules concerning to whom an isolation context can talk and who can talk to the isolation context. Such rules allow the isolation context layer around a job to be selectively opened to designated resources. As discussed above, access can be granted to external public networks like the internet, to a corporate network, to a specific service on the corporate network, to services on the platform network. Resources on the platform network are preferably substantially agnostic to location and machines. As compared to implementing different network blocks and splitting apps between network blocks, the method has the benefit of being highly scalable, fast for deployment, highly visible (routing and policy can be inspected tightly controlled), and other suitable benefits.

The method further functions to enable scalable control and deployment of isolation contexts. The secure management of communication at an isolation context level can enable such a scalable platform. Deploying a new isolation context will preferably have multiple rules that configure it for implementation. The method can automatically configure all the rules so that the isolation context becomes rapidly operational. An isolation context can be instantiated through a variation of the method. When an isolation context is established, the isolation context layer is configured, a job or service is configured within the isolation context layer, access is granted or opened to respective resources, the isolation context activates (i.e., the job starts operation), health of the started isolation context is announced, and routes are announced. In some instances, a new isolation context can become operational within 30 seconds. If an isolation context fails to initialize during deployment, an error can be signaled within a similarly short time frame.

As shown in FIG. 5, block S100, which includes distributing a job within an isolation context to a computing platform, functions to wrap a job instance in an isolation context that is deployed to a machine. Distributing the job preferably sets up at least one job instance. However, multiple instances of a job may be setup at one time. Several job instances are preferably distributed within the computing platform, and a set of jobs can form an architecture of a larger application system. For example, a developer building an application in cloud hosted system will deploy numerous jobs and instances of those jobs; and the jobs will cooperatively operate to execute the service/features offered by that developer's application.

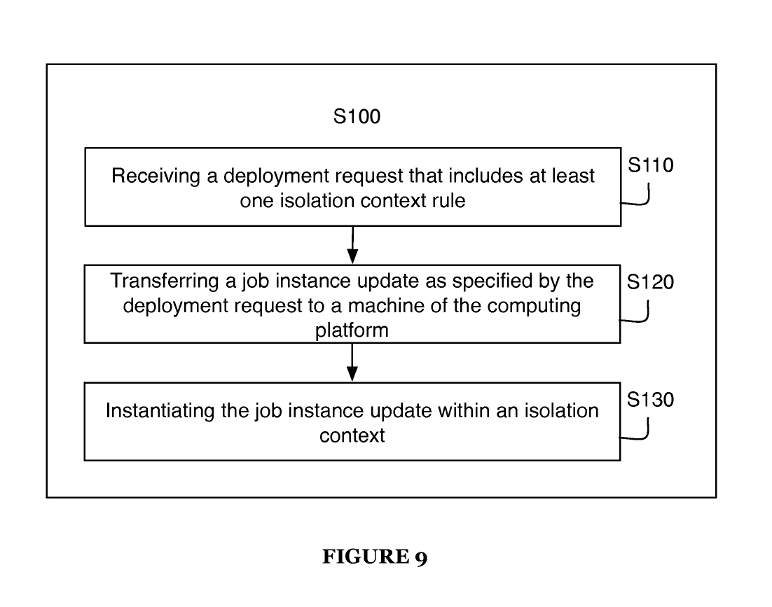

Distributing a job preferably involves the transfer of instructions about the job and how it should be setup within an isolation context and then the wrapping of that job within the isolation context. As shown in FIG. 9, block S100 can include receiving a deployment request that includes at least one isolation context rule S110; transferring a job instance update as specified by the deployment request to a machine of the computing platform S120; at the machine, instantiating the job instance update within an isolation context S130.

Block S110, which includes receiving a deployment request that includes at least one isolation context rule, functions to obtain a rule request concerning a job through an interface of the computing platform. Receiving a rule request through an API functions to obtain direction from an outside entity. The rule request can be submitted by an administrator controlling an application deployed on the platform network or alternatively by an outside application/service programmatically interfacing with an application deployed on the platform network. The deployment request can include a request to deploy a new job with at least isolation context rule. The deployment request may alternatively be an update of an isolation context rule for one or more current job instances. Additionally, the deployment request may general job instance actions such as move, restart, spin up more instances, teardown/remove, and other suitable actions. A isolation context rule set is preferably a policy configuration definition that defines a rule for restrictions on the isolation context related to resource usage and/or networking rules. A job manager service may store and manage a repository of the deployment requests. The stored version may form a canonical version of the deployed jobs or optionally the deployed job instance. For example, the job resources used to setup the job with the isolation context can be stored along with all the isolation context rules that are used in defining the isolation context.

One variation preferably enables resource usage quotas to be set for the isolation context. A resource usage quota can limit memory, disk, CPU usage, bandwidth, feature/library usage, and/or any suitable device level usage restrictions. The limits may be rate limits, percentage limits, total limits, and/or any suitable type of limit. Default amounts may be set by the computing platform or configured per account.

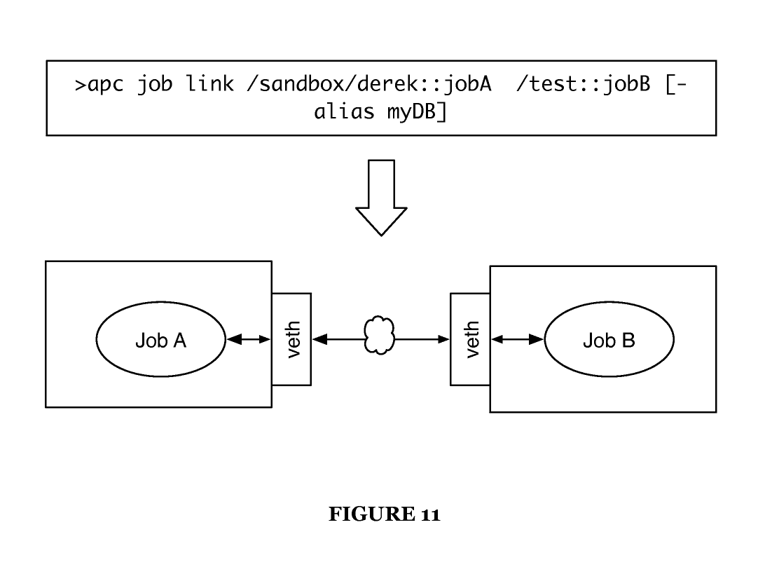

A networking rule of an isolation context can include route rules for ingress traffic (inbound traffic originating outside of the job instance) and connections for egress rules (e.g., bindings or links for outbound traffic from the job to an outside resource). A networking rule will preferably determine who or to whom at least one isolation container can communicate. A connection is preferably a URI association between a client and a server (e.g., two jobs) For example, an entity can submit a rule request of connecting a job ‘foo’ with a first database. A binding is a connection or association between the instance of the job and a fixed endpoint. The binding is preferably not changed for the lifetime of the job instance. Through the virtual network interfaces, the job instance can maintain a static networking rule with outside resources, changes to an outside resource (or of the job instance) are preferably dynamically and automatically updated through the outer virtual network interface on the host OS. A networking rule can open traffic to and from the job instance to other resources within the computing platform or outside the computing platform (e.g., to an enterprise network or the Internet). A connection networking rule may be a binding or a link. A networking rule link is a source side rule that represents the environments variables for the IP and Port of a destination receiver. In one implementation, a link will trigger an appropriate routing rule within IPtables for the source to reach the correct destination. Bindings may be a higher form of a connection with a URI that provides IP, Port with credentials, scheme, and other parameters that can be presented in a URI format. A binding preferably connects a job instance to a service. A binding may connect the job using a URI that points the job to a server directly, to another job that the first job interacts with directly to obtain a service, or, in one variation, to an intermediary proxy to a job/server. The intermediary proxy can be a semantic pipeline, where regulation and additional policy may be applied to the communication. A binding preferably includes a URI with the host and port of the service when the service is running outside the computing platform, and the UUID and port of the job when the service is running within the computing platform. In one variation, a job instance can have a networking rule around the traffic to another job instance in the computing platform. Job instances may be named within the computing platform. Names may be globally scoped, scoped within an account, scoped within an application, or have any suitable namespace scope. Additionally, outside services or endpoints may additionally be assigned a name and referenced by name. For example, a developer tool may enable a command to be issued using named job instance entities to be linked as shown in FIG. 11. In this example, the command may link jobA and provide environment variables inside of the parameterized environment to reach job. The environment variables are preferably prefixed with the local name or alias of jobB.

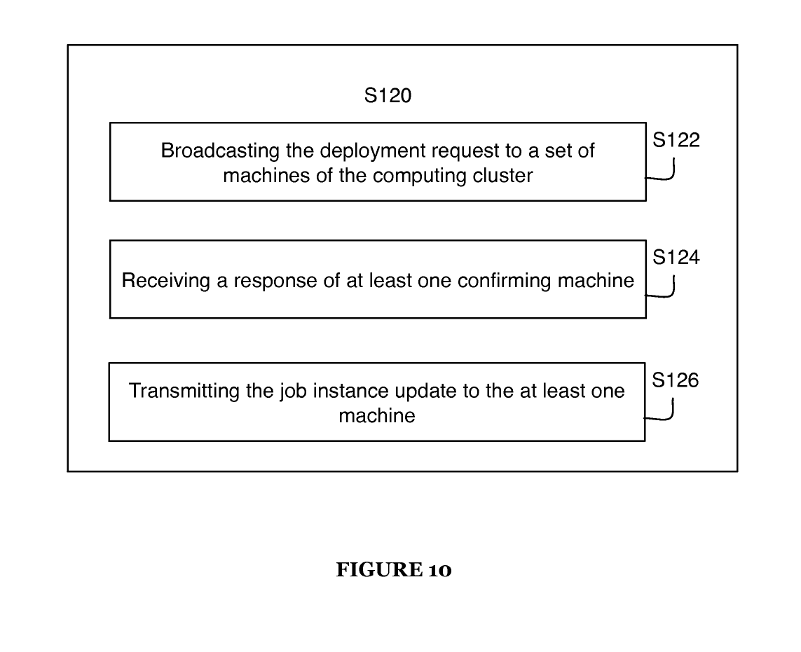

Block S120, which includes transferring job instance update as specified by the deployment request to a machine of the computing platform, functions to identify a suitable machine and setup the job instance within an isolation context. A job manager preferably facilitates the transfer of a job instance update. Block S120 can include broadcasting the deployment request to a set of machines of the computing cluster S122, receiving a response of at least one confirming machine S124, and transmitting the job instance update to the at least one machine S126 as shown in FIG. 10.

Block S122, which includes broadcasting the deployment request to a set of machines of the computing cluster, functions to message at least one machine to confirm that the job instance update can be fulfilled. Preferably, a job manager will employ a messaging system of the computing platform to inquire if a subset of machines are able to and willing to handle the job instance update. One type of deployment request is for deployment of a new job instance. The job manager will identify a set of machines that are capable of hosting the job instance. A machine may not be capable if it does not have appropriate capabilities or if it does not have capacity, A broadcasted message is preferably globally broadcasts messages within the platform network. A message may alternatively be transmitted to a targeted subset of machines. Another type of deployment request may be for a particular job type or job instance. For example, if a network rule is to be updated, the deployment request may be for all job instances of type ‘foo’. In this variation, the message may be broadcasted to all the relevant job instances. The broadcasted messages may be encrypted and digitally signed, which can only be decrypted by targeted recipients. An auth service can facilitate distribution of keys, tokens, certificate, or other suitable cryptographic mechanisms to respective components of the platform network.

Block S124, which includes receiving a response of at least one confirming machine, functions to obtain at least one response of a machine capable of handling the job instance update. As described above, at least a subset of machines receive the broadcasted message. An instance manager or other suitable element on the machine preferably processes the message and determines if the machine can fulfill the deployment request. For example, if the deployment request is for the setup of a new job instance, the instance manager of the machine can inspect if the machine has the capabilities required of the job. The instance manager may additionally or alternatively evaluate if the machine has capacity to handle the job instance—a machine may have multiple other job instances running within isolation contexts at a given time. An instance manager can confirm that it can handle the request or it may inform the job manager it cannot run the job instance (alternatively, it may not respond as indication it will not host the job instance). In some cases, machines may have different preferences for hosting the job instance. For example, a machine with no load may have high preference for taking on a job instance, while a machine with limited capacity will prefer to not add the job instance. In one variation, the method can employ an preference augmented binary response heuristic, which functions to use delayed confirmation to bias the decision to transfer a job to a machine. For example, the job manager may make a request about establishing a new job for a Windows service. The binary portion of the heuristic includes instance managers replying with a binary yes or no if they can fulfill a request. If the answer is yes, the instance manager can apply the time delay taint heuristic. If the answer is no, the instance manager may simply not respond, but can alternatively respond indicating failure to help. For example, if the instance manager is a Linux system, the binary heuristic will be a no. The taint heuristic artificially delays responses according various factors. The factors can include memory pressure, CPU pressure, job list, and other factors. The job list is preferably used to avoid clustering of jobs on the same host. These factors determine a delay, and then response is made indicating suitability to help. The job manager then preferably accepts the desired number of instance managers. In some cases, only a single response is required. The request can additionally be canceled after the request is fulfilled.

In an alternative operation mode, the deployment request is for a targeted isolation context receiving the message. As shown in FIG. 5, numerous instance managers can be instantiated within the platform network. Of those, only a sub-set of isolation contexts of an instance manager may be intended destinations of the message. A message is preferably intended for the isolation context, if the isolation context configuration includes credentials to decrypt the message. In a special case, only a single instance of an isolation context is targeted. In another special case, all isolation contexts of the platform network are targeted. Block S122 and S124 can include encrypting and digitally signing messages of the job manager and at a job instance (i.e., a machine) authenticating the source of the deployment request. In one variation, an instance manager will be set with authentication credentials for a variety of targeting scopes. The method can include distributing cryptographic tokens to instance mangers. For example, a first credential may be for global messages for an account; a second credential may be for a job type; and a third credential may be for a particular job instance. With multiple credentials, messages (e.g., deployment requests and job instance updated) may be broadcast across the computing platform while only job instances with the appropriate credentials can access the content. When multiple isolation contexts are targeted, each targeted isolation context preferably attempts to open communication access.

A job manager preferably receives at least one response of an instance manager, which functions to indicate that the machine is able to host the job instance. In one scenario, a single machine responds, and the job instance is preferably transferred to that machine. In another scenario, multiple machines respond. As another variation, the response of a machine may indicate the number of instances the machine has capacity for. The job manager can maintain a list of available machines and selecting at least a subset of the machines. In some situations a job will be deployed to multiple instances in which case multiple machines can be selected. In another variation, the list can be maintained for subsequent similar requests. The job manager may additionally process the list of available machines to identify a preferred machine. For example, selecting a machine may include identifying a machine within the computing platform according to network topology proximity to dependent jobs, machine capability, and/or any suitable property.

Block S126, which includes transmitting the job instance update to the at least one machine, functions to transfer the job instance update to a selected machine. The message preferably includes instruction and configuration information to direct an isolation context to establish granted access. In the case, that the machine should setup a job, the job instance update may additionally include the resource of a job. Additionally or alternatively, the job instance update may include any suitable resource or networking rule set. The job instance update is preferably transferred from the job instance to the selected machine. The contents of the transmission are preferably encrypted so that the machine can authenticate the origin of the job instance update.

In addition to transmitting the job instance update, which is fulfilled in block S130, the method may additionally include notifying and updating related isolation contexts of job instances. Other isolation contexts of other jobs may be registered to announcements relating to the newly updated job. The job instance and its network routing information may be announced and then other instance managers for other jobs may hear and update networking routing configuration of the isolation context. Preferably, the actual job instance is kept constant. The view of the outside world for a job is substantially static with regard to changes in the computing platform. The outer virtual network interfaces of the virtual network are preferably updated with networking rule changes to account for the new information of the job instance. An isolation context may be updated when that job instance is directly dependent on that job. However, an isolation context may be updated to build out job instance redundancy or failovers or for any suitable reason. For example, a new job instance may cause the new job instance to be automatically added to a list of job instances used as an endpoint for a second endpoint. Communication from that second endpoint may be load balanced across the list of job instances. The load balancing is preferably transparent to the second job, which uses a static network binding within the virtual network.

Block S130, which includes instantiating the job instance update within an isolation context, functions to complete the job instance update. Instantiating the job instance update may comprise setting up an isolation context with any isolation context rules and, if required, building/compiling/launching the job within the isolation context. When the deployment request directs the starting of a new job instance or alternatively the restarting of a job instance, an isolation context object is setup on the selected machine. An installation process or other suitable process is preferably run for the job.

Setting up an isolation context can include configuring isolation context rules, which can define a set of resource quotas and networking rules of the isolation context according to the isolation context rules. The isolation context rules may be new rules or may be changes to existing rules. Configuring a set of resource quotas can set the restrictions on usage amounts for various aspects of the machine such as disk, memory, CPU, bandwidth, and other suitable machine operational properties within the isolation context.

Changing network communication access as specified by the rule request functions to grant or restrict access to specified components. A change to an isolation context may open communication access to one or more entities. The change may alternatively be redirecting communication to a different entity or closing communication to an entity. The entities can be within the computing platform or external to the computing platform. The isolation context layer preferably has a channel or opening enabled to allow ingress and/or egress communication with a specified resource or resources. The communication is preferably packet-based communication. Setting up an isolation context additionally includes establishing an inner virtual network interface of the job instance to which the job creates static network bindings and an outer virtual network with dynamically updated network bindings responsive to changes of job instances of interest.

Block S200, which includes enforcing a set of resource and networking rules of the isolation context during operation of the job, functions to run the job instance while enforcing the isolation context rules regarding the resource usage and the networking routing. The job preferably runs within the isolated environment. Resource usage may be restricted. For example, disk and memory may be artificially limited. CPU usage may be throttled or otherwise limited. The communication to outside entities is preferably performed within the job instance using static naming/identification of endpoints. For example, IP and/or port of a bound database is preferably some internally static location. External to the job instance, within the external layer of the isolation context the location of the bound database may be dynamically updated to reflect a true location within the computing platform or external to the platform.

Enforcing the networking rules can include enforcing routes of ingress traffic or the bindings/links of egress traffic. The traffic is preferably packet based communication. The packets may be rewritten and otherwise updated to set source and/or destination endpoints according to the view of a resource in the network.

For example, ingress packets (i.e., packets bound for an isolation context) traverse from etho to vetho by matching a rewrite rule for a specific ephemeral port assigned to that isolation context. A rewrite rule can modify a destination IP of a packet to that of the virtual interface. Processes can declare routes, which can optionally specify ports. If ports are specified, an applications configuration can be such that the application expects connections on those ports and open them inside the isolation container. If routes of a process do not specify ports, a randomly selected port (preferably a high port) is chosen and provided to the process through an environment variable. Egress packets (i.e., packets flowing out of the isolation context) hosted to the internet via vethi to vetho to etho can be masqueraded such that the source address is ehto's IP and an ephemeral port is chosen by a kernel. Packets returning to the port can be returned to vetho and then to vethi by the kernel.

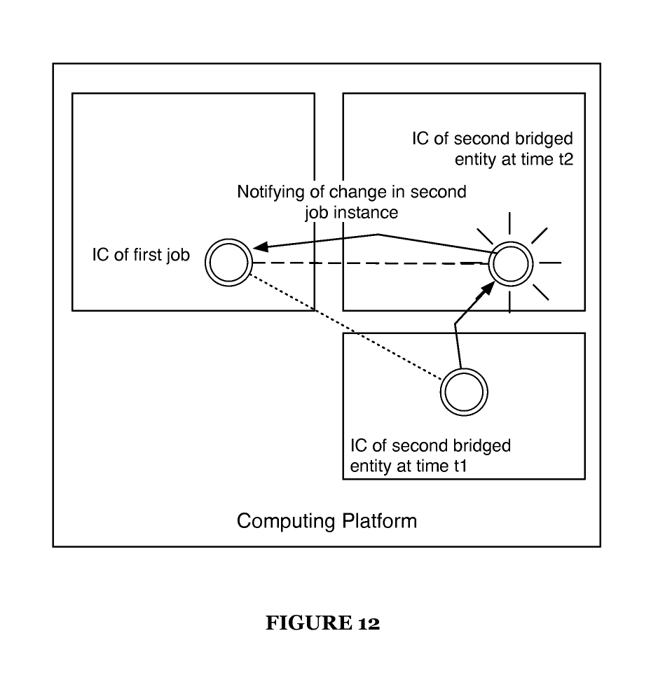

Enforcing a set of resource and networking rules of the isolation context during operation of the job S200 can additionally include updating the isolation context in response to changes of at least a second job instance as shown in FIG. 12. Various scenarios of enforcing the isolation context rules can be created depending on job instance dependencies, topology, and the type of state change. As mentioned above, multiple job instances are distributed within the computing platform. The below description will refer to a the distribution of a second job instance within an isolation context, but the scenarios may additionally be occur for any number or combination of job instances. Additional job instances preferably experience substantially similar management, distribution, execution, and enforcement within the computing platform. For a the situation of a first job having dependence on a second job instance, the isolation context of the first job preferably opens networking communication in at least one direction with the second job instance. The second job instance can similarly open networking access in the inverse direction. Opening networking communication can include setting a mapping within an outer virtual network interface of the first job instance. Wherein the outer virtual network interface maps communication to the location of the second job instance. In some cases, the communication may alternatively be routed to some internal resource such as a semantic pipeline, but with that communication later directed to the second job instance.

In one scenario, the method can include changing deployment of the second job instance to a new machine location within the computing platform. The location of the second job instance changes. The IP address, port, authentication, and/or any suitable aspect may change. Such a change may occur in response to the second job instance going down and needing to restart or being redeployed. Such a change preferably triggers updating the mapping within the outer virtual network of the isolation context of the first job. The inner virtual network mapping preferably remains constant to the job instance.

In another scenario, the method can accommodate the second job instance being deployed on the same machine as the first job instance. The first and second job instances are preferably not exposed to the fact that the job instances are on the same or different machine. However, preference for close proximity of two job instances may be requested in a deployment request. The method preferably short-circuits communication to prevent “tromboning” or the case of sending communication outside of the machine to a gateway so that it can be returned to the same location. The method preferably maps the outer virtual network interface with a routing internal to the machine of the first and second job instances. The communication avoids leaving the machine.

In another scenario, the first job instance registers to monitor notifications about the second job. When the second job instance is setup or when it updates, the first job instance may update a list of job instances and their respective status. This can function to maintain a collection of backup, failover, or supplementary job instances that can fulfill the service objectives for the first job. For example, if an initially mapped second job instance becomes unavailable, the method preferably dynamically remaps the outer network of the first job to a select new instance of the second job from the set of instances of the second job. In one case, an instance manager can facilitate load balancing across the set of available instances of the second job in the computing platform.

The system and method of the preferred embodiment and variations thereof can be embodied and/or implemented at least in part as a machine configured to receive a computer-readable medium storing computer-readable instructions. The instructions are preferably executed by computer-executable components preferably integrated with the platform network and isolation contexts. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

As a person skilled in the art will recognize from the previous detailed description and from the figures and claims, modifications and changes can be made to the preferred embodiments of the invention without departing from the scope of this invention defined in the following claims.

What is claimed is:

1. A method for operating a computing platform comprising:
distributing a job within an isolation context to a computing platform, which comprises:
receiving a deployment request that includes a set of isolation context rules;
transferring a job instance update as specified by the deployment request to a machine of the computing platform;
at the machine, instantiating the job instance within an isolation context and configuring the set of isolation context rules as a set of resource quotas and networking rules of the isolation context; and
enforcing the set of resource quotas and networking rules during operation of the job instance within the computing platform.

2. The method of claim 1, wherein instantiating the job instance within an isolation context comprises setting up a job within an operating system level virtualization container object.

3. The method of claim 2, wherein configuring the set of isolation context rules as a set of networking rules of the isolation context comprises configuring one of IPtables, a generic route encapsulation (GRE) mechanism, or vSwitches.

4. The method of claim 1, wherein the set of resource quotas defines limits on memory, disk, bandwidth, and computation consumed by the job instance on the machine.

5. The method of claim 1, wherein the set of networking rules includes route rules for ingress traffic and a set of bindings and links for egress traffic.

6. The method of claim 1, wherein instantiating the job instance within an isolation context comprises establishing an inner virtual network interface of the job to which the job creates static bindings and an outer virtual network interface with dynamically updated bindings responsive to updates in the computing platform.

7. The method of claim 6, further comprising distributing a second job instance within an isolation context to a computing platform; wherein the networking rule of the first job instance opens networking communication in at least one direction, which comprises setting a mapping within the outer virtual network of the first job according to an endpoint location of the second job instance.

8. The method of claim 7, further comprising changing deployment of the second job instance to a new machine within the computing platform; and updating the mapping within the outer virtual network interface of the first job instance according to a new endpoint location of the second job instance.

9. The method of claim 7, wherein the second job instance is distributed to the same machine as the first job instance, and further comprising updating the communication mapping of the outer virtual network for internal routing of the communication between the first and second job instances.

10. The method of claim 7, wherein a set of instances of the second job are distributed within the computing platform and monitored by an instance manager of the first job instance; and wherein setting a mapping of the outer virtual network interface comprises load balancing across the set of instances of the second job.

11. The method of claim 7, wherein, when an initially mapped second instance of the second job becomes unavailable, dynamically remapping the outer network of the first job to select a new instance of the second job from the set of instances of the second job.

12. The method of claim 1, further comprising distributing a second job instance within an isolation context to a computing platform; wherein the isolation context of the first job instance is instantiated in a first operating environment and the isolation context of the second job instance is instantiated in a second operating environment.

13. The method of claim 1, wherein transferring a job instance update as specified by the deployment request to a machine of the computing platform comprises a job manager broadcasting the deployment request to a set of machines of the computing cluster, receiving a response of at least one confirming machine, and transmitting the job instance update to at least one machine.

14. The method of claim 13, wherein a machine randomly delays responding to the deployment request and ignores the deployment request if the machine cannot fulfill the deployment request.

15. The method of claim 13, wherein transmitting the job instance update to at least one machine further comprises encrypting and digitally signing the job instance update, and at the machine, authenticating the source of the job instance update.

16. The method of claim 13, wherein multiple machines respond to the deployment request broadcast; and further comprising maintaining a list of available machines and sending the job instance update to at least a subset of machines from the list of available machines.

17. The method of claim 1, wherein transferring a job instance update as specified by the deployment request to a machine of the computing platform comprises identifying a machine within the computing platform according to network topology proximity to dependent jobs and machine capability.

18. A system for a computing platform comprising:
a computing platform that includes a set of host machines;
a set of isolation containers deployed across the set of host machines, wherein the set of isolation containers includes at least one job instance running on the machine;
a host machine comprising a virtual network between a host operating system and an isolation context on the machine, the virtual network including an inner virtual network interface proximal to the isolation context and an outer virtual network interface proximal to the host operating system;
a platform network between the set of host machines;
a corporate network to an external network environment; and
the isolation context including an isolation context rules that define resource usage quotas and rules of ingress and egress communication traffic.

19. The system of claim 18, further comprising a set of internal services, which comprise an API service, a messaging system, instance managers operating on the host machines, a job manager that communicatively broadcasts deployment request messages to the instance managers.

20. The method of claim 18, wherein the corporate network is a public internet gateway.

21. The method of claim 18, wherein the corporate network includes an on-premise network.
